(19) United States
(12) Patent Application Publication
(10) Pub. No.: US 2025/0200035 A1
(43) Pub. Date: Jun. 19, 2025

(54) RETRIEVAL, MODEL-DRIVEN, AND ARTIFICIAL INTELLIGENCE-ENABLED SEARCH

(71) Applicant: HEWLETT PACKARD ENTERPRISE DEVELOPMENT LP, Spring, TX (US)

(72) Inventors: Sreenivas Rangan Sukumar, Seattle, WA (US); Christopher Douglas Rickett, Fort Collins, CO (US); Kristyn J. Maschhoff, Seattle, WA (US); Sarah Elizabeth Nguyen, Seattle, WA (US)

(21) Appl. No.: 18/852,168

(22) PCT Filed: Jun. 24, 2022
(86) PCT No.: PCT/US2022/034947

§ 371 Date: Sep. 27, 2024

(51) Int. Cl. G06F 16/2453

(52) U.S. Cl. CPC G06F 16/24537

(57) ABSTRACT

Systems and methods disclosed herein may include a plurality of operators to search and retrieve various types of data in a result set, simultaneously. The operators may include a retrieval operator, user defined function (UDF) operator, and artificial intelligence (AI) operator in communication with an interface layer and multiple shards of a database for generating the result set.

### BACKGROUND

In traditional systems, data is stored separately based on the data type, making it difficult to query across multiple data types. This query process across the multiple types of data can be time-consuming, due to the volume, complexity, and multiple modalities of the data. For example, today there are over 33 exabytes of geo-spatial data (e.g., satellite raster scans, aerial/cosmological images, 3D point clouds, elevation maps and meshes). Various database types attempt to work with large sets of structured, semi-structured, or unstructured data, but rarely do these databases run efficiently or provide search results that accurately find all possible data items related to the search query.

### BRIEF DESCRIPTION OF THE DRAWINGS

The present disclosure, in accordance with one or more various examples, is described in detail with reference to the following figures. The figures are provided for purposes of illustration only and merely depict typical examples.

FIG. 1 illustrates an example system with compute nodes, in accordance with various examples.

FIG. 2 illustrates an example system with compute nodes for processing the received search query, in accordance with various examples.

FIG. 3 illustrates an example system with a retrieval operator, user defined function (UDF) operator, and artificial intelligence (AI) operator in communication with an interface layer and multiple shards of a database for processing the received search query, in accordance with various examples.

FIG. 4 illustrates an example system with a retrieval operator, UDF operator, and AI operator in communication with an interface layer and multiple shards of a database for generating the result set, in accordance with various examples.

FIG. 5 illustrates an example implementation of the UDF operator and search query, in accordance with various examples.

FIG. 6 illustrates an example computing component that may be used in accordance with various examples.

FIG. 7 is an example computing component that may be used to implement various features of examples described in the present disclosure.

The figures are not exhaustive and do not limit the present disclosure to the precise form disclosed.

### DETAILED DESCRIPTION

Systems and methods disclosed herein may include a plurality of operators to search and retrieve various types of data in a result set, simultaneously. The operators may include a retrieval operator, user defined function (UDF) operator, and artificial intelligence (AI) operator in communication with an interface layer and multiple shards of a data structure for generating the result set.

The data may be searched in response to receiving a search query from a user. The search query can request one or more data items of various data types, including structured, semi-structured, or unstructured data. The search query may correspond with a particular query language (e.g., SPARQL query language, etc.). The system can join various sets of data stored in one or more data stores into an interface layer. The interface layer may interact with a retrieval operator, UDF operator, and AI operator to access the data stored with multiple shards of a data store or data structure to determine which of the data satisfy one or more conditions corresponding with each operator. With the retrieval operator, the condition may be associated with the data corresponding with a data attribute of the search query. With the UDF operator, the condition may be associated with the data exceeding a similarity score. The similarity score can be determined by the user or may be a default value. In some examples, the similarity score may represent a probability, ranking, or other similarity value. With the AI operator, the condition may be associated with the data being matched to an attribute of the search query, which uses one or more artificial intelligence models to determine a match. The data that satisfies a condition, exceeds a similarity score, or returns as matches can be merged into the result set. The result set may take the form of a hash table, vector, key-value index, or feature embeddings that are provided to a user interface. In some examples, the hash table may comprise a data structure for structured and unstructured types of data that can map keys to values. In some examples, the hash table may use a hash function to compute an array that sorts the data results according to data type or other attributes.

Improvements to technology are provided throughout the application as filed. For example, improvements can be made to performance and scalability on supercomputer products with general-purpose processors using a high-performance interconnect. Examples may include enhancements to traditional data stores (e.g., graph databases) that can improve the performance of database operations. These operations may enable users to compare terms that are found as part of a search query to apply an order or ranking to the search results. The raw strings for these terms may be stored in the dictionary, which may be implemented as a distributed hash table that spreads the strings across all processes. This distribution of the terms results in an increase in efficiency of processing and retrieving different data types simultaneously (e.g., absent multiple queries).

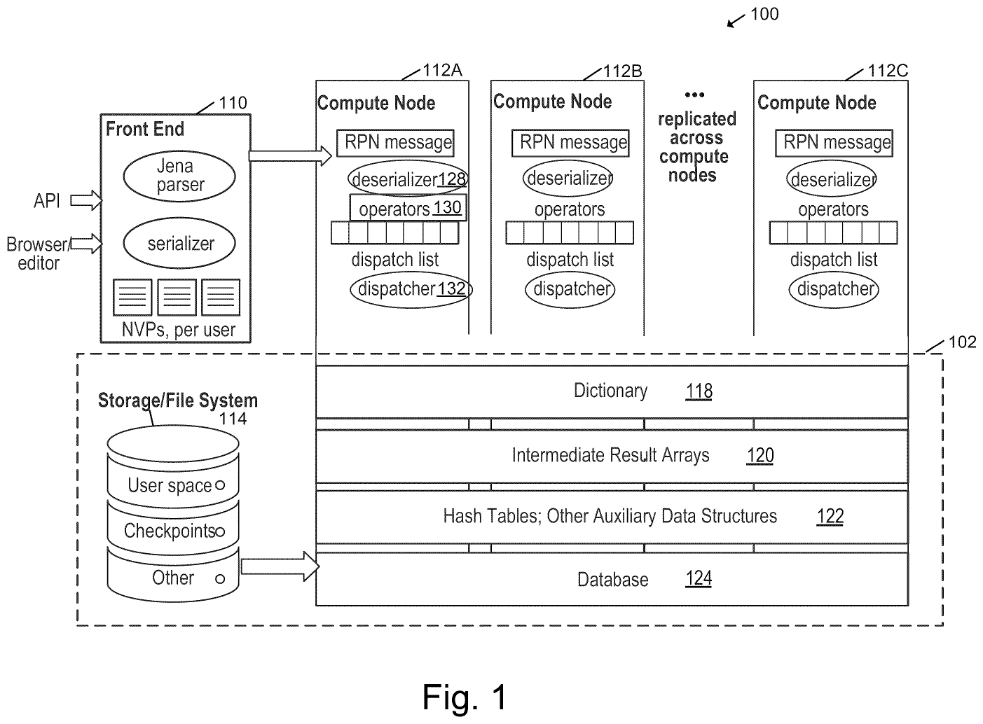

FIG. 1 illustrates an example system with compute nodes, in accordance with various examples. System 100 includes a plurality of resources replicated across multiple compute nodes or images 112 (illustrated as first compute node 112A, second compute node 112B, and third compute node 112C). These resources can include, for example, deserializer 128, operator 130, and dispatcher 132. Access to the plurality of resources may be provided through front end 110.

System 100 may comprise one or more data stores 102 distributed across compute nodes or images 112. The components of the data stores 102 may comprise, for example, dictionary 118, intermediate result arrays 120, hash tables and other auxiliary data structures 122, and database 124. Storage file system 114 can be used to accommodate database 124 as well as user spaces, checkpoints, and other data.

One or more data stores 102 may comprise one or more types of data structures for storing structured and unstructured data, including an in-memory semantic graph database. Other types of databases may be implemented without diverting from the scope of the disclosure. One or more data stores 102 may be designed to scale to hundreds of nodes and tens of thousands of processes to support interactive querying of large data sets (˜100 s of terabytes). The data stores ingest datasets of N-Triples/N-Quads through various implementations. For example, ingesting the datasets may be based on a Resource Description Framework (RDF) format and may also accept one or more search queries using the SPARQL query language. The RDF format may be expressed as a labeled, directed graph. The RDF format may correspond with a quad formatting consisting of four fields: subject, predicate, object and graph, or a triple formatting with fewer fields. For example, the following is a simplified version of an example RDF triple that could be loaded into the data stores:
<urn:P0DTC25> <urn:mnemonic> “SPIKE_SARS2”

One or more data stores 102 may include a network of possible connections. Vertices or nodes generally refer to entities (e.g., data, people, businesses, etc.) and connections between entities are edges. One or more data stores 102 can be used to identify entities connected to other entities. Generally, local processing can be used to process small amounts of data around compute node 112. Other tasks may involve evaluating edges/connections on a more holistic basis (e.g., in a whole data store or graph analysis).

One or more data stores 102 may be used to generate a semantic graph by system 100. The semantic graph may include a collection of such triples with subjects and objects representing vertices and predicates representing edges between the vertices. Semantic graph databases differ from relational databases in that the underlying data structure is a graph, rather than a structured set of tables in a data store.

Generation of the semantic graph may be accomplished by the backend query engine that runs across compute nodes 112, with the input being distributed across the compute nodes 112 and each node generating a subset of the semantic graph. The final semantic graph is built by syncing the subsets across the compute nodes 112 to remove duplicates.

In various examples, one or more data stores 102 may include two main components: the dictionary and the query engine. Dictionary 118 is responsible for building the data store, which is the process of ingesting raw N-Triples/N-Quads files from a high performance parallel file system (e.g., Lustre® file system) and converting them to the internal representation used by the data stores 102. Dictionary 118 stores the unique RDF strings from the N-Triples/N-Quads and provides a mapping between the unique strings and the integer identifiers used for the quads internally by the query engine. The query engine may be implemented to process the search query, update requests, or provide a number of built-in graph algorithms (e.g., measures of centrality, PageRank, or connectivity analysis) that can be applied to query data and help return search results as a result set to the user.

Dictionary 118 may comprise a mapping of RDF strings to integer identifiers and the storage of the internal quads are implemented, for example, using distributed hash tables. Each compute node used by the backend query engine may access or store a subset of the complete hash table. In some examples, compute nodes 112 can access the hash table data held by any of the other compute nodes. During query execution, the intermediate results of each step may be saved in an intermediate results array (IRA), which may be distributed across the compute nodes 112.

Front end 110 of system 100 can receive one or more search queries from a user via an application programming interface (API), browser/editor, or other component to access system 100. Front end 110 provides an interface by which a user can interact with the system such as, for example, by submitting queries and receiving results back from the queries. System 100 may be implemented on hardware that can be built on top of a partitioned global address space which may allow the system to treat independent processes, nodes, and images as their own entity, but can subdivide data and share data across the images using a communication library, which may be different than dictionary 118. The communication library can be used for remote processes to exchange data and coordinate operations. System 100 may be configured to run thousands of compute images 112 in a coordinated manner, in which all can run independently on their own subset and the later synchronized when needed for results using the communication library.

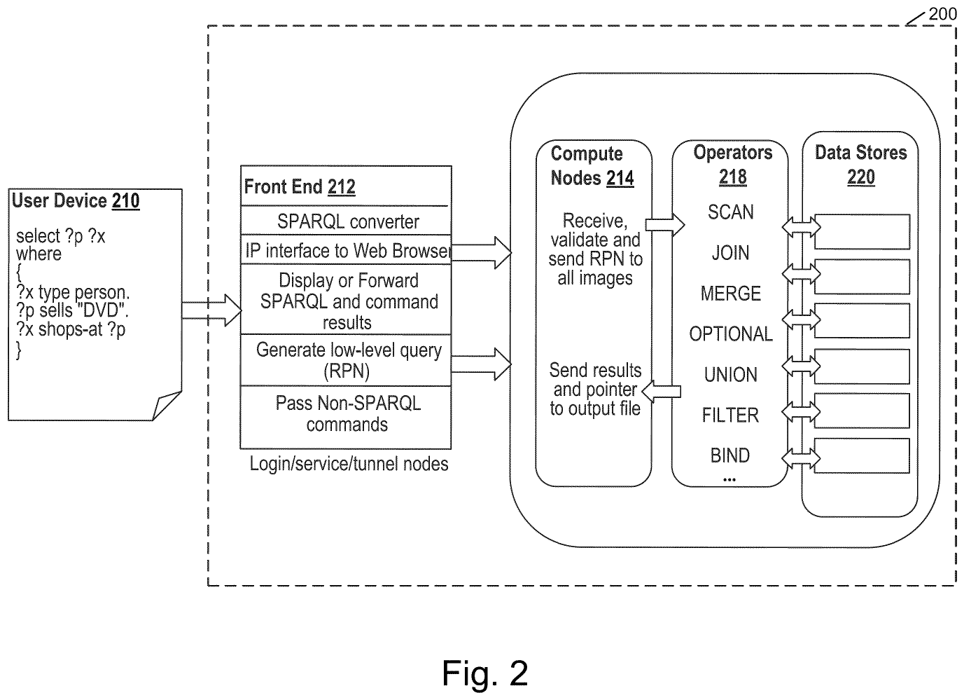

FIG. 2 illustrates an example system with compute nodes for processing the search query, in accordance with various examples. For example, system 200 of FIG. 2 may correspond with system 100 of FIG. 1. Additionally, front end 110, compute node 112, and one or more data stores 102 of FIG. 1 may correspond with front end 212, compute nodes 214, and data stores 220 of FIG. 1.

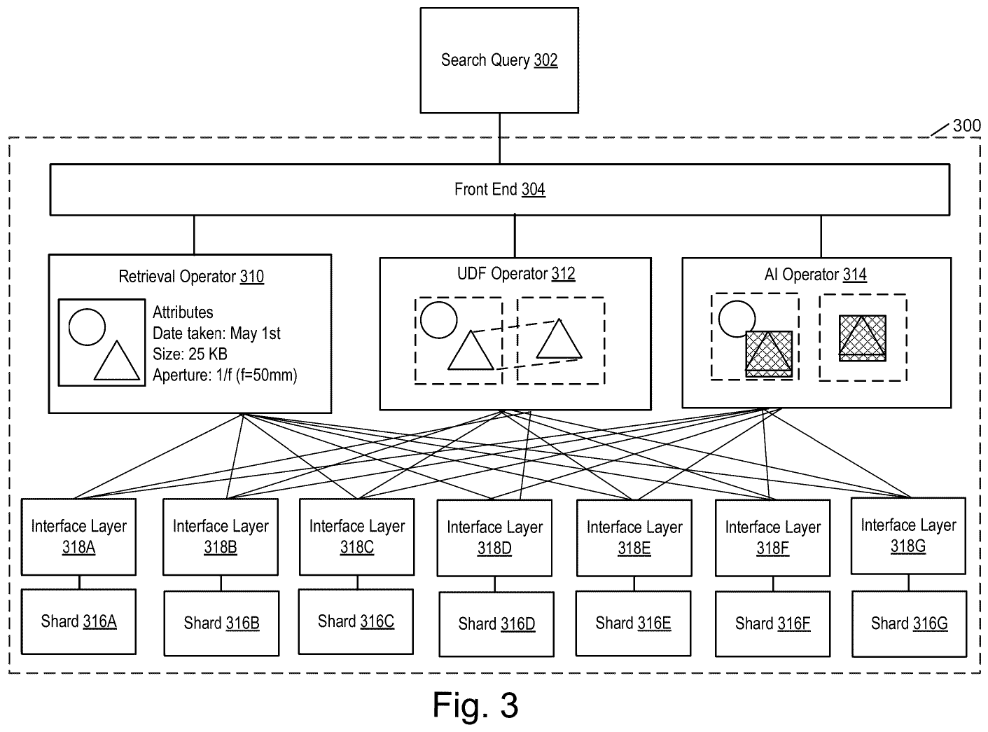

System 200 may receive a search query from user device 210, which can submit the search query through front end implemented as one or more of the interfaces discussed herein. The search query can be converted (e.g., using the SPARQL query language format) by front end 212 and submitted to compute nodes 214, which perform various operations on the data to determine an applicable search result set. In some examples, an interface layer may enable communication and control between front end 212 and the stored data (e.g., separated into shards as illustrated in FIG. 3). Compute nodes 214 can receive the search query and execute one or more operators 218 to perform the query operations on the data items stored in data stores 220. Operators 218 included in this example are SCAN, JOIN, MERGE, OPTIONAL, UNION, FILTER and BIND, although other operations can be used. These operations can be used to traverse the data in various data stores 220 in different ways to fulfill a search query.

FIG. 3 illustrates an example system with a retrieval operator, user defined function (UDF) operator, and artificial intelligence (AI) operator in communication with an interface layer and multiple shards of a database for processing the search query, in accordance with various examples. For example, system 300 and front end 304 of FIG. 3 may correspond with system 100 and front end 110 of FIG. 1, respectively.

In this illustration, search query 300 can be submitted from a user device to front end 304 of system 300. An illustrative search query is provided herein:

select distinct ?protB ?sim_orig ?seqB ?seq
where {
?protein a core:Protein ;
core:mnemonic ‘SPIKE_SARS2’ ;
core:sequence ?isoform .
?isoform rdf:value ?seq .
?targetcmpt cco:targetCmptXref ?protB .
?target cco:has TargetComponent ?targetcmpt .
?assay cco:hasTarget ?target .
?protB a core:Protein ;
core:sequence ?isoformB ;
up:recommendedName ?recommended .
?recommended up:fullName ?name .
?isoformB rdf:value ?seqB .

Front end 304 may pass the attributes of search query 302 across multiple operators, including the retrieval operator 310, UDF operator 312, or the AI operator 314. Using these operators, system 300 can access and analyze a plurality of data sets of various data types simultaneously.

Retrieval operator 310, UDF operator 312, and AI operator 314 can query across a plurality of interface layers 318 (illustrated as first interface layer 318A, second interface layer 318B, third interface layer 318C, fourth interface layer 318D, fifth interface layer 318E, sixth interface layer 318F, and seventh interface layer 318G). Interface layer 318 may be implemented as a hash table, vector embeddings, feature embeddings, key-value index embeddings, or other data structure. Interface layer 318 may comprise all sets of structured and unstructured data returned from shards 316, as described herein.

Shard 316 (illustrated as first shard 316A, second shard 316B, third shard 316C, fourth shard 316D, fifth shard 316E, sixth shard 316F, and seventh shard 316G) may correspond with a partition of a data store, where the data store includes structured or unstructured data. Each data set may comprise a plurality of shards 316, where each shard 316 may correspond with a partition of data in the data store. For all data sets, the interface layer may join all sets of data into a hash table or other data structure. This hash table can be queried with a retrieval operator 310, UDF operator 312, and AI operator 314. Retrieval operator 310 can query the semantic graph or data store based on a dictionary search, which determines whether data items comprise a desired attribute or operating characteristic. As an example, a data item may have attributes such as date, size, and aperture. The retrieval operator 310 can determine whether an attribute exists, and return a data item that comprise the requested attributes.

Operators 310, 312, and 314 may query all shards through interface layer 318 to provide search results to the user that span multiple data types. These data types can include graphs, sequences, molecules, video, images, text, and any other data type. Interface layer 318 facilitates providing a single data set to the user in response to search query 302.

Retrieval operator 310 is configured to identify one or more attributes of data items in the data store that would correspond with the attributes requested in search query 302.

UDF operator 312 uses pre-defined or dynamic user-defined functions to generate a comparison between two or more data items. These functions can be written by the user to apply domain specific knowledge to the query result set. The graph database can provide a generic function that users can overwrite with their own function that the graph database can load into memory at program startup. The graph database can define the function in order to enable passing parameters to the user function and allow users to return information to the graph database for the purpose of evaluating an expression for an operator. The information returned to the graph database by the user defined function can enable the domain specific function to rank or filter search results. In various examples, the system can be configured such that the user can add user-defined functions to perform custom searches/queries.

Front end 304, via UDF operator 312, may also be configured to allow generation of custom functions inside query expressions to enable domain specific operations on data as part of the search query. This is a feature that can allow users to define, express, and execute domain-specific mathematical operations to evaluate and rank search results (e.g., when the function is not otherwise supported in the SPARQL query language). Such graph operations can be implemented as custom functions that are defined by the uniform recourse identifier (URI) in expressions. This capability may be configured to allow users to define their own function. An illustrative call to these user-defined functions may comprise, for example:
prefix arq: <http://jena.hp1.hp.com/ARQ/function #>
. . .
arq:sqrt(5)
. . .

UDF operator 312 can determine the similarity between two data items based on the user-defined functions. This similarity may take the form of a similarity score, which may be applied in response to the search query or based on the relationship between two data items within the data store. The similarity score may be determined based on numerical, geometric, combinatorial, or string-matching algorithms using distributed methods. The user-defined function operator can set a threshold similarity score that can dictate what data items are returned to the user in response to the search query. As an example, the user-defined function operator may set a similarity threshold of 0.8. This similarity threshold can be matched or exceeded to return the data item to the user. Using this example, a data item with a similarity score of 0.9 would be returned to the user, while a data item with a similarity score of 0.5 would not exceed that threshold and thus would not be a part of the search results. The user-defined function operator can create a set of search results based on the data items that match or exceed the similarity score to return to the user. The UDF operator 312 can create new attributes for data items based on these similarity scores. These new attributes may contribute to future queries through retrieval operator 310 or AI operator 314.

AI operator 314 can use a plurality of AI models to receive one or more data items as input to the AI model, and produce an output. The output is compared with attributes of the search query to determine whether output from the AI model matches the data items. The AI models predict relationships between data items and determine a match based on one or more conditions associated with each model. As an illustrative example, one AI model can determine whether a cat is in an image, while a separate model can determine whether the article discusses illnesses associated with cats. Both of these data items, relating to images and articles, may be considered a match to the search query associated with “cats.”

These matches can also comprise cross-modality predictions such as image-to-text relationships, video-to-image relationships, etc. The use of multiple models by AI operator 314 assists in providing search results that are approximate matches as opposed to only exact matches. These AI models can be pretrained to determine a search result set from one or more search queries, where the search results include a determined relationship or pattern. AI operator 314 determines whether data items are a match for each applicable AI model and provides any matching data items to front end 304 as part of the search results.

AI operator 314 may also be configured to create new attributes for data items based on the matches or predictions. These new attributes may contribute to future queries through retrieval operator 310 or UDF operator 312 as well.

The search results from each of operators 310, 312, and 314 may be provided to interface layer 318. Interface layer 318 may implement one or more functions on the returned data. As illustrated, interface layer 318 may implement a set of bind functions to scan, join, and merge the data sets of structured and unstructured data into a searchable format at interface layer 318. An illustrative bind function is provided herein.

{
bind(arq:user_func(‘ssw’, ?seq, ?seqB) as ?sim_orig)
filter(?sim_orig >= 0.184)
}
?targetcmpt cco:targetCmptXref ?protB .
?target cco:hasTargetComponent ?targetcmpt .
?assay cco:hasTarget ?target ;
cco:assayType ?assayType .
?protB up:organism ?taxon .
?taxon core:scientificName ?sciName .
{
bind(arq:user_func(‘dtba’, ?smiles, ?seq) as ?dtba)
filter(?dtba >= 6.5)
}
order by desc(?sim_orig) desc(?dtba)

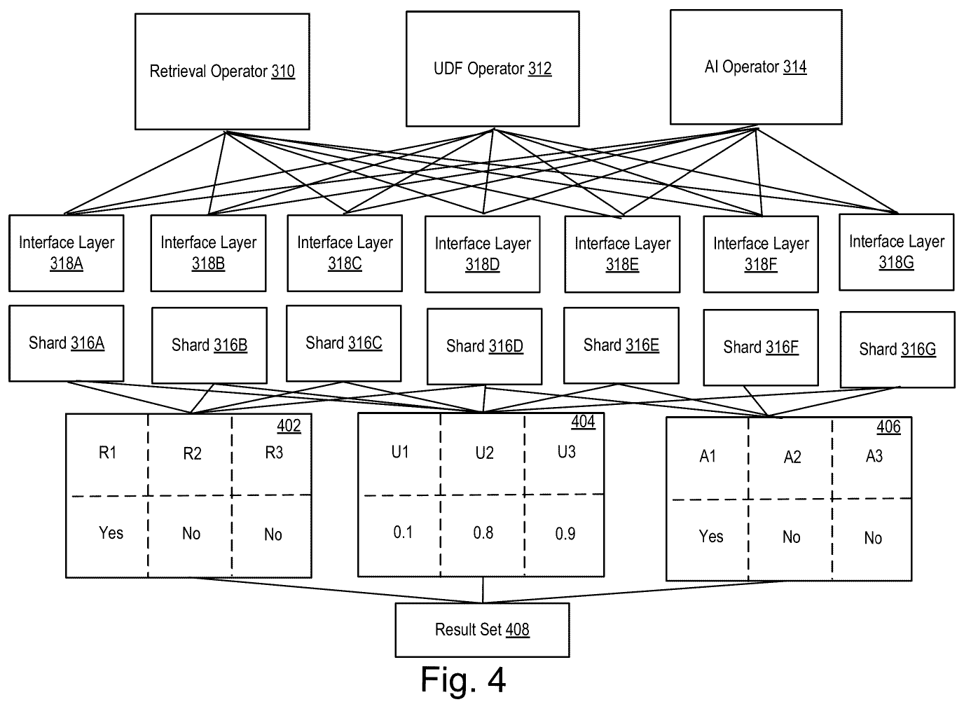

FIG. 4 illustrates an example system with a retrieval operator, UDF operator, and AI operator in communication with an interface layer and multiple shards of a database for generating the result set, in accordance with various examples. In this example, operators 310, 312, and 314, interface layers 318, and shards 316 of system 300 of FIG. 3 are repeated in FIG. 4 to return result set 408.

Tables 402, 404, and 406 are also provided to store temporary data. For example, retrieval operator 310 may execute machine readable instructions to generate yes/no determinations. These instructions may determine whether a data item has a particular attribute as described herein. These search results may be stored in a table or dataset 402 to become a part of result set 408. In another example, UDF operator 312 may record similarity scores in a table 404 to be added to result set 408. In another example, AI operator 314 may execute machine readable instructions to generate yes/no determinations. These instructions may determine the output based on the matches received from a plurality of AI models, as described herein. These search results can be stored at table 406 to be returned as a part of result set 408.

Result set 408 may comprise one or more data structures in various formats for storing data tables 402, 404, and 406. Result set 408 can be returned to the user as a single dataset or other predefined formats (e.g., defined by a user profile or other customizable options, to optimize the user experience). In some examples, result set 408 can be stored in a data store of system 300 of FIG. 3, comprising structured and unstructured data, where the data may be returned in response to future search queries.

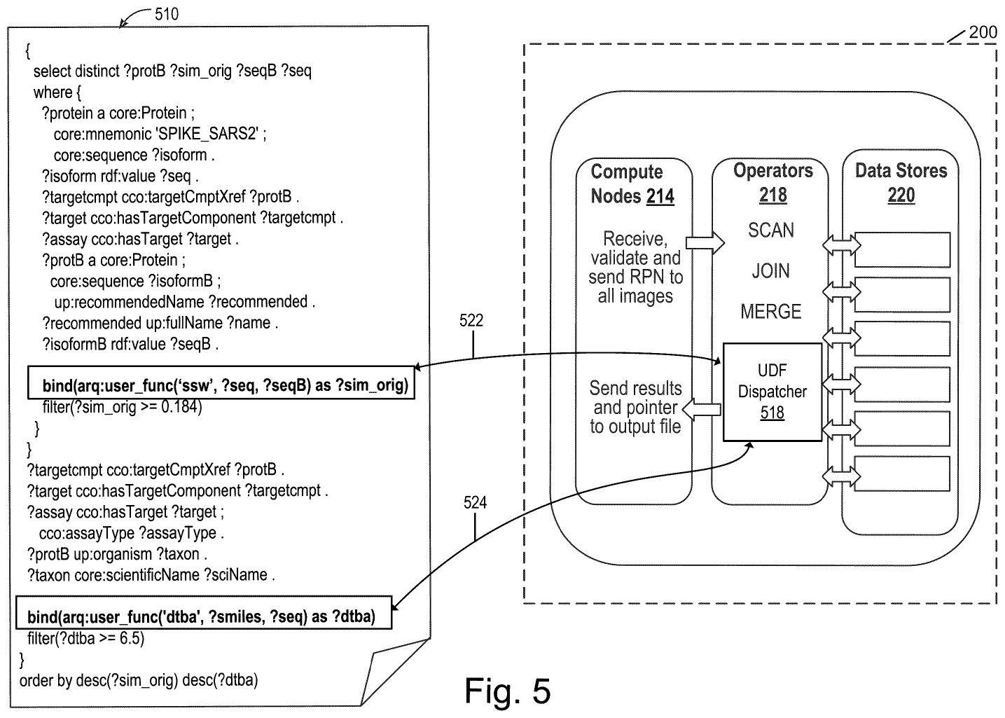

FIG. 5 illustrates an example implementation of the UDF operator and search query, in accordance with various examples. In this illustration, UDF dispatcher 518 is provided in the context of system 200, compute nodes 214, operators 218, and data stores 220 of FIG. 2. Other portions of system 200 are removed for simplicity of explanation in this context.

Search query 510 they can be submitted to system 200 and operators 218 may determine applicable data from data stores 220, as described herein. In this example, search query 510 includes a request for data associated with a SARS2 spike protein, and the search query includes a mnemonic, which in this example is ‘SPIKE_SARS2’. This portion of search query 510 also identifies the protein sequence for the condition of interest, which in this case is a virus.

Search query 510 also comprises one or more bind sequences 522, 524. The bind sequences 522, 524 in search query 510 trigger UDF dispatcher 518 to join the sets of structured and unstructured data. The data may be provided as a result set (e.g., result set 408 in FIG. 4) and provided to a user interface accessible by user device operated by user. As described above, result set may include feature embeddings, vector embeddings, and key-value index embeddings, or other data structure components.

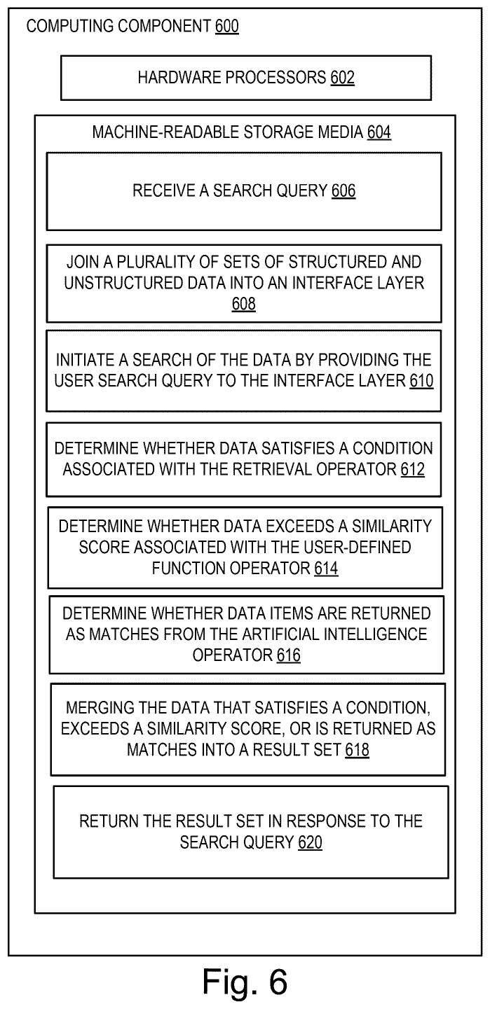

FIG. 6 illustrates an example computing component 600 that may be used to retrieve various types of data in a result set, simultaneously, in accordance with one example of the disclosed technology. Computing component 600 may be, for example, a server computer, a controller, or any other similar computing component capable of processing data. In the example implementation of FIG. 6, the computing component 600 includes a hardware processor 602, and machine-readable storage medium 604. Hardware processor 602 may be one or more central processing units (CPUs), semiconductor-based microprocessors, and/or other hardware devices suitable for retrieval and execution of instructions stored in machine-readable storage medium 604. Hardware processor 602 may fetch, decode, and execute instructions, such as instructions 606-618, to retrieve various types of data in a result set, simultaneously. As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 604, may be any electronic, magnetic, optical, or other physical storage device that contains or stores executable instructions. Thus, machine-readable storage medium 604 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 604 may be a non-transitory storage medium, where the term “non-transitory” does not encompass transitory propagating signals. As described in detail below, machine-readable storage medium 604 may be encoded with executable instructions, for example, instructions 606-618.

Hardware processor 602 may execute instruction 606 to receive search query associated with one or more sets of structured and unstructured data. These sets of structured and unstructured data may be partitioned into a plurality of shards, as described above (see, e.g. shard 316 of FIG. 3).

Hardware processor 602 may execute instruction 608 to join the plurality of sets of structured and unstructured data into an interface layer (see, e.g. interface layer 318 of FIG. 3), where the interface layer is implemented using a hash table, vector embeddings, key-value index embeddings, or feature embeddings. As described above, the interface layer can provide communication and control to the front end (e.g., front end 212 of FIG. 2) and the back end compute nodes (e.g., compute nodes 214 of FIG. 2). The data may be joined in accordance with bind sequences provided in the search query that are then executed by the dispatcher (e.g., UDF dispatcher 518 of FIG. 5).

Hardware processor 602 may execute instruction 610 to initiate a search of the plurality of sets of structured and unstructured data by providing the search query to the front end or to the interface layer. As described above, this interface layer may provide access to the data stores using a retrieval operator, UDF operator, and AI operator (see, e.g. operators 310, 312, and 314). These operators can access the plurality of shards associated with the data stores (e.g., shards 316 of FIG. 3).

Hardware processor 602 may execute instruction 612 to determine whether one or more data items within the interface layer satisfies a condition associated with the retrieval operator. As described above, retrieval operator such as operator 310 can query interface layer 318 based on a dictionary search, which determines whether data items comprise a desired attribute or operating characteristic. Retrieval operator 310 can determine whether an attribute exists, and return a data item that comprise the requested attributes. These data items can become a part of the result set that can be returned to the user.

Hardware processor 602 may execute instruction 614 to determine whether data exceeds a similarity score associated with the UDF operator. As described above, the UDF operator can determine the similarity between two data items based on the user-defined functions. The similarity score may be determined based on numerical, geometric, combinatorial, or string-matching algorithms using distributed methods. UDF operator can set a threshold similarity score that can dictate what data items are returned to the user in response to the search query. The user-defined function operator can create a set of search results based on the data items that match or exceed the similarity score to return to the user.

Hardware processor 602 may execute instruction 616 to determine whether data items are returned as matches from the AI operator. As described above, the AI operator can use one or more artificial intelligence models to determine whether data items are a match. The models predict relationships between data items and determine a match based on one or more conditions associated with each model. These matches can also comprise cross-modality predictions. The AI operator determines whether data items are a match for each applicable artificial intelligence model and provides all matching data items to the user as part of the result set.

Hardware processor 602 may execute instruction 618 to merge the data that satisfies a condition, exceeds a similarity score, or is returned as matches into a result set. These search results can be stored as a table to be returned to the user device. The result set may comprise a data structure (e.g., hash table) of data received from the retrieval operator, UDF operator, and AI operator. The result set can be stored in the data store of structured and unstructured data to be returned for future queries. Hardware processor 602 may execute instruction 620 to return the data set to the user in the form of this data structure.

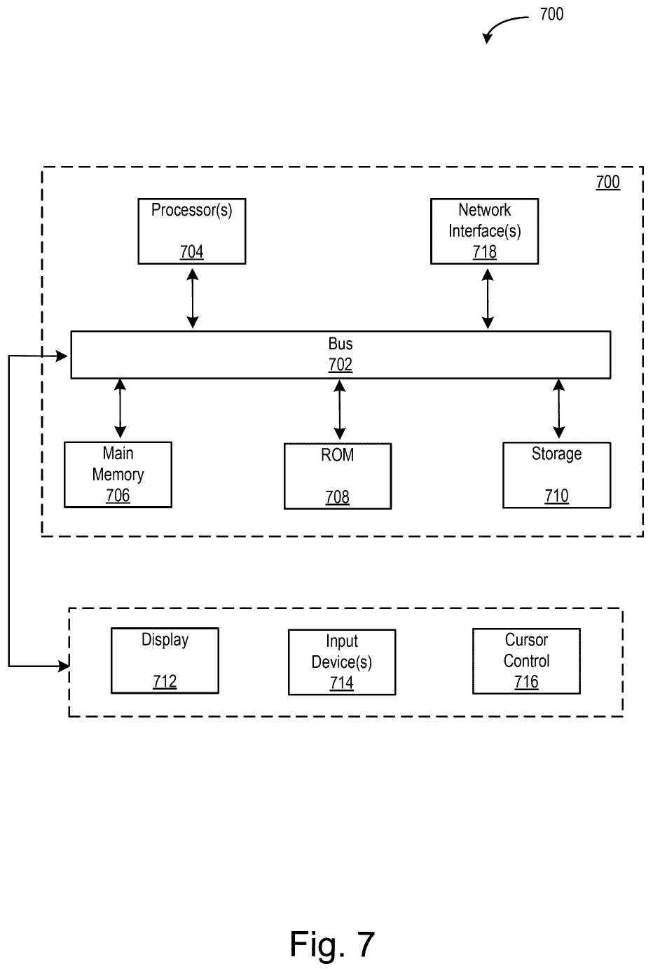

FIG. 7 depicts a block diagram of an example computer system 700 in which various of the examples described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a liquid crystal display (LCD) (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. In some examples, the same direction information and command selections as cursor control may be implemented via receiving touches on a touch screen without a cursor.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one example, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 706 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

The computer system 700 also includes network interface 718 coupled to bus 702. Network interface 718 provides a two-way data communication coupling to one or more network links that are connected to one or more local networks. For example, network interface 718 may be an integrated services digital network (ISDN) card, cable modem, satellite modem, or a modem to provide a data communication connection to a corresponding type of telephone line. As another example, network interface 718 may be a local area network (LAN) card to provide a data communication connection to a compatible LAN (or WAN component to communicated with a WAN). Wireless links may also be implemented. In any such implementation, network interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through network interface 718, which carry the digital data to and from computer system 700, are example forms of transmission media.

Computer system 700 can send messages and receive data, including program code, through the network(s), network link and network interface 718. In the Internet example, a server might transmit a requested code for an application program through the Internet, the ISP, the local network and network interface 718.

The received code may be executed by processor 704 as it is received, and/or stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computing device comprising:
a memory; and
one or more processors that are configured to execute machine readable instructions stored in the memory for:
receiving a search query associated with a plurality of sets of structured and unstructured data;
joining the plurality of sets of structured and unstructured data into an interface layer, wherein the interface layer is implemented using a hash table, vector embeddings, key-value index embeddings, or feature embeddings;
initiating a search of the plurality of sets of structured and unstructured data by providing the search query to the interface layer, wherein the search of the plurality of sets of structured and unstructured data uses a retrieval operator, a user-defined function (UDF) operator, and an artificial intelligence (AI) operator submitted to the interface layer;
determining whether one or more data items within the interface layer satisfies a condition associated with the retrieval operator;
determining whether one or more data items within the interface layer exceeds a similarity score associated with the UDF operator;
determining whether one or more data items within the interface layer are returned as matches from the AI operator, wherein the AI operator provides the matches from one or more AI models;
merging the one or more data items that satisfy the condition associated with the retrieval operator, one or more data items that exceeds the similarity score associated with the UDF operator, and the one or more data items returned as matches from the AI operator into a result set; and
returning the result set in response to the search query.

2. The computing device of claim 1, wherein the plurality of sets of structured and unstructured data comprises an in-memory semantic graph database.

3. The computing device of claim 1, wherein the plurality of sets of structured and unstructured data are partitioned into a plurality of shards.

4. The computing device of claim 1, wherein determining whether one or more data items within the interface layer satisfies the condition associated with the retrieval operator comprises determining an attribute associated with the condition and returning one or more data items that comprise the attribute.

5. The computing device of claim 1, wherein the similarity score is determined based on numerical, geometric, combinatorial, or string-matching algorithms using distributed methods.

6. The computing device of claim 1, wherein the UDF operator comprises one or more user-defined functions that determine the similarity score.

7. The computing device of claim 1, wherein the matches from the AI operator comprise cross-modality predictions.

8. The computing device of claim 1, wherein the result set comprises a subset of a semantic graph that satisfies the condition associated with the retrieval operator.

9. The computing device of claim 1, wherein the search query is written in a SPARQL query language.

10. A computer-implemented method comprising:
receiving, at a computing device, a search query associated with a plurality of sets of structured and unstructured data;
joining, at the computing device, the plurality of sets of structured and unstructured data into an interface layer, wherein the interface layer is implemented using a hash table, vector embeddings, key-value index embeddings, or feature embeddings;
initiating, at the computing device, a search of the plurality of sets of structured and unstructured data by providing the search query to the interface layer, wherein the search of the plurality of sets of structured and unstructured data uses a retrieval operator, a user-defined function (UDF) operator, and an artificial intelligence (AI) operator submitted to the interface layer;
determining whether one or more data items within the interface layer satisfies a condition associated with the retrieval operator;
determining whether one or more data items within the interface layer exceeds a similarity score associated with the UDF operator;
determining whether one or more data items within the interface layer are returned as matches from the AI operator, wherein the AI operator provides the matches from one or more AI models;
merging, at the computing device, the one or more data items that satisfy the condition associated with the retrieval operator, one or more data items that exceeds the similarity score associated with the UDF operator, and the one or more data items returned as matches from the AI operator into a result set; and
returning, at the computing device, the result set in response to the search query.

11. The method of claim 10, wherein the plurality of sets of structured and unstructured data comprises an in-memory semantic graph database.

12. The method of claim 10, wherein the plurality of sets of structured and unstructured data are partitioned into a plurality of shards.

13. The method of claim 10, wherein determining whether one or more data items within the interface layer satisfies the condition associated with the retrieval operator comprises determining an attribute associated with the condition and returning one or more data items that comprise the attribute.

14. The method of claim 10, wherein the similarity score is determined based on numerical, geometric, combinatorial, or string-matching algorithms using distributed methods.

15. The method of claim 10, wherein the UDF operator comprises one or more user-defined functions that determine the similarity score.

16. The method of claim 10, wherein the matches from the AI operator comprise cross-modality predictions.

17. The method of claim 10, wherein the result set comprises a subset of a semantic graph that satisfies the condition associated with the retrieval operator.

18. The method of claim 10, wherein the search query is written in a SPARQL query language.

19. A non-transitory computer-readable storage medium storing a plurality of instructions executable by one or more processors, the plurality of instructions when executed by the one or more processors cause the one or more processors to:
receive a search query associated with a plurality of sets of structured and unstructured data;
join the plurality of sets of structured and unstructured data into an interface layer, wherein the interface layer is implemented using a hash table, vector embeddings, key-value index embeddings, or feature embeddings;
initiate a search of the plurality of sets of structured and unstructured data by providing the search query to the interface layer, wherein the search of the plurality of sets of structured and unstructured data uses a retrieval operator, a user-defined function (UDF) operator, and an artificial intelligence (AI) operator submitted to the interface layer;
determine whether one or more data items within the interface layer satisfies a condition associated with the retrieval operator;
determine whether one or more data items within the interface layer exceeds a similarity score associated with the UDF operator;
determine whether one or more data items within the interface layer are returned as matches from the AI operator, wherein the AI operator provides the matches from one or more AI models;
merge the one or more data items that satisfy the condition associated with the retrieval operator, one or more data items that exceeds the similarity score associated with the UDF operator, and the one or more data items returned as matches from the AI operator into a result set; and
return the result set in response to the search query.

20. The non-transitory computer-readable storage medium of claim 19, wherein the plurality of sets of structured and unstructured data comprises an in-memory semantic graph database.
